(19) United States
(12) Patent Application Publication
(10) Pub. No.: US 2010/0279913 A1
(43) Pub. Date: Nov. 4, 2010

(54) Compositions

(75) Inventors: Charlotta Larrson, Prague (CZ); Frederic Moreux, Granollers (ES); Gunnar Noding, Ludwigshafen (DE)

Correspondence Address: PARFOMAK, ANDREW N.;NORRIS MCLAUGHLIN & MARCUS PA, 875 THIRD AVE, 8TH FLOOR, NEW YORK, NY, 10022, US

(73) Assignee: Reckitt Benckiser N. V., Hoofddorp (NL)

(21) Appl. No.: 12/672,414

(22) PCT Filed: Aug. 11, 2008
(86) PCT No.: PCT/GB2008/002702

§ 371 Date: Jul. 7, 2010

(30) Foreign Application Priority Data
Aug. 10, 2007 (GB) 0715605.2

(51) Int. Cl. B65D 65/46; C11D 17/04

(52) U.S. Cl. 510/224

(57) ABSTRACT

A water-soluble package comprising at least two water-soluble bodies, preferably detergent compositions, wherein the at least two bodies are not adhered to each other by an adhesive and are retained in positions relative to one another by a water-soluble film surrounding the bodies. These bodies have good dissolution properties in water and are dimensionally stable.

### TECHNICAL FIELD

The present invention relates to a water-soluble package comprising at least two water-soluble bodies and to packaging therefor.

### BACKGROUND AND PRIOR ART

Tablets of a compressed particulate composition for use in dishwashing machines or laundry washing machines are well known. Such tablets are added to the machine at the start of its operation and are fully consumed by the end of the operation. Examples of such tablets are dishwashing tablets such as those sold under the trade mark Finish, water-softening tablets such as those sold under the trade mark Calgon, and laundry detergent tablets such as those sold under the trade mark Persil. Water soluble films around water soluble bodies are disclosed in US 2006/0040845, WO 2004/046297 and GB 1507744.

Such tablets may comprise a single composition or more than one composition. If more than one composition is present, the compositions are generally present in different parts of the tablets, for example either as separate layers or as compositions held within indentations. A particularly popular arrangement is for a ball of a second composition to be placed in a depression of a first composition, which may itself comprises more than one composition arranged in layers, e.g. producing a multi-layer tablet with an indentation in the upper surface of the tablet with the identation containing a separate phase such as a ball.

Although these arrangements are broadly acceptable there remains scope for improvement. If the layers are held together by an adhesive, such as PEG, the bodies may become separated, particularly if the tablets are stored for a lengthy period of time. If an incomplete tablet is used in a washing process the process will not be satisfactory since at least some of the components necessary for the washing process may be omitted. Furthermore, tablets comprising separate layers of different compositions are conventionally prepared by progressively compressing different particulate compositions on top of the initially prepared layer. This can subject the initial layer, and further layers, to multiple compression steps. This may affect the compaction of at least some of the layers, leading to dissolution problems of the lowermost layer. While different layers may be independently prepared and then adhered together with an adhesive, this can lead to the same adhesion problem as discussed above.

It is an object of the present invention to overcome or at least alleviate any or all of the above problems.

### STATEMENT OF INVENTION

The present invention provides a water-soluble package comprising at least two water-soluble bodies, wherein the at least two bodies are not adhered to each other by an adhesive and are retained in positions relative to one another by a water-soluble film surrounding the bodies.

It is preferred that at least one and preferably at least two body/bodies is/are formed of a compressed particulate composition. It is also preferred that at least one body comprises an indentation into which is situated a second body, such as a spherical body.

It is preferred that the water soluble is a fabric care, surface care or dishwashing package.

The water-soluble film which surrounds the bodies is preferably a poly(vinyl alcohol) film, and it is further preferred that this film is thermoformed.

Although the water soluble packages of the invention may be put into any sort of outer container for sale to the consumer, it is preferred that a primary package comprising two or more compartments which can be opened individually and wherein at least one compartment is substantially air-tight before it is opened for the first time is used with each compartment comprising a plurality of packages according to invention.

This present invention allows for water soluble packages to be produced which are tightly held by a surrounding water-soluble wrapper and which do not require the use of adhesive compounds which may fail, add expense and interfere with the dissolution of the water-soluble bodies.

### DETAILED DESCRIPTION

In the packages of the present invention, the at least two bodies are held together by a water-soluble film surrounding the bodies, that is, the water soluble film tights closely around the two bodies. This closely-fitting film ensures that the bodies do not move relative to each other. Thus, for instance, in the case of a layered tablet, the layers are prevented from parting or sliding across each other by the surrounding film. Similarly, in the case of a ball held within an indentation, the ball is prevented from falling out of the indentation by the water-soluble film holding it in. This arrangement ensures that the components are always held together and, furthermore, allows that either lower than usual compaction pressures can be used as there is no requirement to adhere the bodies together by means of compression or ensures that multiple compression steps do not need to be carried out.

### Wrapping Process

The present invention also provides a process for preparing a package as according to the invention by providing at least one first body, placing at least one second body abutting said at least one first body and wrapping a water-soluble film around the bodies, or by thermoforming a first water-soluble film to provide a pocket, placing at least one first body in said pocket, placing at least one second body abutting said at least one first body, placing a second water-soluble film on top of the pocket and sealing the first film and second film together.

Thermoforming the film to be wrapped around the two or more bodies is preferred.

The water-soluble film may be applied to the bodies by any method. Suitable methods include thermoforming and wrapping. However, with all processes the wrapper should be allied so that it is sufficiently closely fitting to provide for the bodies not to move relative to each other but without requiring the use of an adhesive agent to bind them to each other.

WO 06/095190, which is incorporated by reference herein, discloses a process for packaging compacted particulate compositions, especially bodies of such material, by which the resistance of the composition to physical damage is surprisingly increased. This allows for a wider range of physical properties of the bodies to be tolerated, such as reduced hardness and increased friability, thus allowing a wider window of ingredient selection and manufacturing tolerances. Thus the bodies wrapped by the process exhibit good dissolution properties in water. The process comprises wrapping a body of detergent composition in a water soluble film by wrapping it with a first film and treating the wrapped body at an elevated temperature to shrink the film such that it clings to said composition.

Flow wrapping is particularly preferred for wrapping the bodies in the water soluble wrapper. Generally flow wrapping comprises sealing peripheral regions of a web of film around an object to form a tube with a longitudinal seam. The two ends of the tube are sealed around the product being packaged by transverse seams. In forming the transverse seams the longitudinal seam is brought next to the surface of the packaged product and is normally disposed in the middle of the rear face of the packaging.

This method of wrapping compacted particulate compositions with a film of material is straightforward and economical, when compared to, for example, dipping or spray coating.

The film is preferably sealed together in a known manner. Sealing can simply occur under the forming conditions used, particularly when heat and/or pressure are used. However, it is also possible for additional sealing techniques to be used. For example, heat sealing or infra-red, radio frequency, ultrasonic, laser, solvent, adhesive, vibration, electromagnetic, hot gas, hot plate or insert bonding friction sealing, cold sealing or spin welding can be used. Heat sealing is preferred.

Heat sealing conditions depend on the machine and material used. Generally the sealing temperature is from 100 to 180° C. The pressure is usually from 100 to 500 kPa (1 to 5 bar). The dwell time is generally from 0.02 to 0.6 seconds.

A heat treatment step may optionally be carried out to shrink the film and this is preferred to provide the close-fitting nature of the wrapper relative to the bodies enclosed therein. The heat treatment step is preferably carried out over a short timescale to avoid thermal damage to the film and/or the bodies. It will be appreciated that the amount of time required for this step will be dependent on the thickness of the film being used. Generally the heat treatment step is carried out in a time of 0.1 to 5 seconds, more preferably 0.2 to 4 seconds, more preferably 0.5 to 2 seconds, more preferably 1.0 to 2.0 seconds, e.g. about 1.5 seconds.

Most preferably the heat treatment step is carried out in a zone through which the wrapped bodies are conveyed. In this way it has been found that the heat treatment step may form part of a production process for a wrapped bodies wherein the process includes other steps, such as the compaction of the composition to produce the bodies. Such processes generally operate at around 1500 individual compacted wrapped bodies per minute on a single operational line. It has been found that advantageously the process of the present invention is able to work with this rate of throughput.

Generally the zone comprises a flow (e.g. in the form of jets) of hot air over the wrapped bodies. Preferably a plurality of jets of hot air are passed over the wrapped bodies. For example a jet of air may be directed at the wrapped bodies from above, below and/or at one or more sides of the bodies. In order that multiple jets of air may be directed at the wrapped bodies preferably they are carried on an apertured conveyor through the zone.

It will be understood that the temperature of the jets of air will depend upon the nature of the wrapped bodies (particularly if the bodies are thermally sensitive) and the film, material being used. Generally the air is heated to a temperature of between 90 to 950° C., more preferably 140 to 800° C., more preferably 180 to 650° C.

It will be appreciated that the film temperature may be lower than the temperature of the air jet. Most preferably the film temperature is between 80 to 220° C. and more preferably 120 to 180° C.

Generally the film has an aperture to allow the release of any trapped air during the heating process. Most preferably the film (when applied to the bodies) has a plurality of apertures. Preferably the apertures are disposed on the upper surface of the bodies. Usually the apertures are applied using a punch. The apertures have a preferred size (before the heat treatment step) of from around 0.1 to 0.3 mm.

A cooling step has been found to be only optional rather than a requisite.

Other methods of preparation of the wrapped tablet include thermoforming, as described, for instance in WO 02/16222. A first film is initially thermoformed to produce a non-planer sheet containing a pocket, such as a recess, which is able to retain the bodies. The pocked is generally bounded by a flange, which is preferably substantially planer. The pocket is then filled with the bodies and a second film is placed on the flange and across the pocket. The second film may or may not be thermoformed. The films are then sealed together, for example by heat sealing across the flange.

A suitable heat sealing temperature is, for example, 120 to 195° C., for example 140 to 150° C. A suitable sealing pressure is, for example, from 250 to 800 kPa. Examples of sealing pressures are 276 to 552 kPa (40 to 80 p.s.i.), especially 345 to 483 kPa (50 to 70 p.s.a.) or 400 to 800 kPa (4 to 8 bar), especially 500 to 700 kPa (5 to 7 bar) depending on the heat sealing machine used. Suitable sealing dwell times are at least 0.4 seconds, for example 0.4 to 2.5 seconds. Other methods or sealing the films together may be used, for example infra-red, radio frequency, ultrasonic, laser, solvent, vibration, electromagnetic, hot gas, hot plate, insert bonding, fraction sealing or spin welding. An adhesive such as water or an aqueous solution of a water soluble polymer such as ply (vinyl alcohol) may also be used. The adhesive can be applied to the films by spraying, transfer coating, roller coating or otherwise coating, or the films can be passed through a mist of the adhesive. The seal desirably is also water-soluble.

If more than one container is formed at the same time, the packaged bodies may then be separated from each other by cutting the flanges. Alternatively, they may be left conjoined and, for example, perforations provided between the individual containers so that they can be easily separated at a later stage, for example by a consumer. If the containers are separated, the flanges may be left in place. However, desirably the flanges are partially removed in order to provide an even more attractive, three-dimensional appearance. Generally the flanges remaining should be as small as possible for aesthetic purposes while bearing in mind that some flange is required to ensure the two films remain adhered to each other. A flange having a width of 1 mm to 10 mm is desirable, preferably 2 mm to 7 mm, more preferably 4 mm to 6 mm, most preferably about 5 mm.

The film used in the process for wrapping the bodies may be any film which is water-soluble or water dispersible. Thus the bodies are preferably wrapped in a outer wrapper which is water soluble or water dispersible. References hereinafter to water soluble also include water dispersible. A water soluble film allows the bodies to be dispersed in an aqueous medium without having to be unwrapped. Preferably the film comprises a polymeric material.

Examples of water-soluble polymers are poly (vinyl alcohol)(PVOH), cellulose derivatives such as hydroxypropyl methyl cellulose (HPMC), gelatin, poly(vinylpyrrolidone), poly(acrylic acid) or an ester thereof or poly(maleic acid) or an ester thereof. Copolymers of any of these polymers may also be used. Poly (vinyl alcohol), and copolymers thereof is especially preferred.

An example of a preferred PVOH is an esterified or etherified PVOH. The PVOH may be partially or fully alcoholised or hydrolysed. For example it may be from 40 to 100%, preferably from 70 to 92%, more preferably about 88% or about 92%, alcoholised or hydrolysed. The degree of hydrolysis is known to influence the temperature at which the PVOH starts to dissolve in water. 88% hydrolysis corresponds to a PVOH soluble in cold (i.e. room temperature) water, whereas 92% hydrolysis corresponds to a PVOH soluble in warm water.

By choosing an appropriate water-soluble polymer it is possible to ensure that it dissolves at a desired temperature. Thus the film may be cold water (20° C.) soluble, but may be insoluble in cold water and only become soluble in warm or hot water having a temperature of, for example, 30° C., 40° C., 50° C. or even 60° C.

Desirably the film consists essentially of, or consists of, the polymer composition. It is possible for suitable additives such as plasticisers, lubricants and colouring agents to be added. A particularly attractive appearance can be achieved by having the films in different colours, or by having one film uncoloured and the other coloured. Components which modify the properties of the polymer may also be added. Plasticisers are generally used in an amount of up to 20 wt %, for example from 5 to 20 wt % or 10 to 20 wt %. Lubricants are generally used in an amount of 0.5 to 5 wt %. The polymer is therefore generally used in an amount of from 75 to 94.5 wt %, based on the total amount of the moulding composition. Suitable plasticisers are, for example, water, pentaerythritols such as depentaerythritol, sorbitol, mannitol, glycerine and glycols such as glycerol, ethylene glycol and polyethylene glycol. Solids such as talc, stearic acid, magnesium stearate, silicon dioxide, zinc stearate or colloidal silica may be used as lubricants.

It is also possible to include one or more particulate solids in the films in order to accelerate the rate of dissolution of the film. Dissolution of the solid in water is sufficient to cause an acceleration in the break-up of the film, particularly if a gas is generated.

Examples of such solids are alkali and alkaline earth metal, such as sodium, potassium, magnesium and calcium, bicarbonate and carbonate, in conjunction with an acid.

Suitable acids are, for example acidic substances having carboxylic or sulfonic acid groups or salts thereof. Examples are cinnamic, tartaric, mandelic, fumaric, maleic, malic, palmoic, citric and naphthalene disulfonic acids, as free acids or as their salts, for example with alkali or alkaline earth metals.

The film may be a single film, or a laminated film as disclosed in GB-A-2,244,258. The layers in a film laminate may be the same or different. Thus the layers may each comprise the same polymer or a different polymer.

The film may be produced by any process, for example by extrusion and blowing or by casting. The film may be unoriented, monoaxially oriented or biaxially oriented. If the layers in the film are oriented, they usually have the same orientation, although their planes of orientation may be different if desired.

The thickness of the film is preferably 10 to 2000 μm, especially 10 to 150 μm and more especially 15 to 80 μm. These measurements are before any heat treatment is applied to shrink the film; after heat treatment some of the film may have a different thickness, particularly around the corners of the wrapped body.

### Water-Soluble Bodies

The water-soluble bodies in the water soluble package are preferably detergent compositions, such as laundry, dishwashing or hard surface cleaning compositions.

The water-soluble bodies contained in the water-soluble package of the present invention may be of any shape, form or composition. One, two, three, four or five or more bodies may be present. Each body may have the same or a different composition from any other body. Each body is preferably solid, although the possibility of including a further liquid in the packages is not excluded, particularly when the packages are formed by thermoforming. The solid bodies may desirably be formed by compressing a particulate composition or may be prepared by setting or gelling a composition in a desired shape. Particularly preferred arrangements are arrangements wherein a complete body is formed of one or more layers of compressed particulate compositions. One or more layers may also be formed of a gelled composition. It is particularly preferred that the uppermost surface of the body, which may itself consist of one, two or three or more layers, contains an indentation into which a ball is placed.

For the purposes of the present invention, it is sufficient that at least two bodies are free to move relative to one another before the water-soluble film surrounds them to hold them in place. Each of the individual bodies may itself contain one or two or more compositions. If each individual body contains two or more compositions, they may again be free to move relative to one another, or it is possible that the individual bodies have been prepared by multiple compressions or by use of an adhesive as in the prior art. Thus, for example, a first body may be in the form of a tablet having two or more layers, wherein the tablet has been formed by a conventional multiple compression process. The second body may be in the form of a ball held within an indentation within the uppermost layer of the first body. The ball may itself be made by compression or another method such as injection moulding.

The compressed bodies may have any desired shape, preferably that of a tablet and the shape of the outside of the packages follows the shape of the bodies. For example the bodies can have a irregular or regular geometrical shape such as a cube, cuboid, pyramid, dodecahedron or cylinder. The cylinder may have any desired cross-section, such as a circular, triangular or square cross-section. They may also comprise a single particulate composition (e.g. two bodies of the same composition) or two, three or even more different compositions. For example, the bodies may comprise two, three or more layers.

The two or more bodies they can have a particularly attractive appearance since they, which may be visually identical or different, may be held in a fixed position in relation to each other. The bodies can be easily differentiated to accentuate their difference. For example, they can have a different physical appearance, or can be coloured differently.

The bodies which can be held in the package may be a fabric care, surface care or dishwashing composition. Thus, for example, they may be a dishwashing, water-softening, laundry or detergent composition, or a rinse aid. Such compositions may be suitable for use in a domestic washing machine.

The bodies may have the same or different size and/or shape. In general, if it is desired to have bodies containing different quantities of components, the bodies have volume ratios of from 1:1 to 20:1, especially from 1:1 to 10:1.

The packages produced by the process of the present invention may, if desired, have a maximum dimension of 10 cm, excluding any flanges. For example, a container may have a length of 1 to 5 cm, especially 3.5 to 4.5 cm, a width of 1.5 to 3.5cm, especially 2 to 3 cm, and a height of 1 to 3 cm, especially 1.0 to 2.0 cm, e.g. 1.8 cm.

The packages containing the bodies as according to the invention generally weigh from 5 to 100 g, especially from 5 to 40 g. For example, a laundry composition may weigh from 15 to 40 g, a dishwashing composition may weigh from 5 to 30 g and a water-softening composition may weigh from 15 to 40 g.

### Ingredients of the Bodies;

If the packages are for use in fabric care, the bodies inside them may comprise, for example, a detergent, bleach, stain remover, water-softener, enzyme and/or fabric conditioner. The bodies may be adapted to release their ingredients at different times during the laundry wash. For example, a bleach or fabric conditioner is generally released at the end of a wash, and a water-softener is generally released at the start of a wash. An enzyme may be released at the start or the end of a wash.

If the packages are for use as a fabric conditioner, the bodies may comprise a fabric conditioner and/or an enzyme which is released before or after the fabric conditioner in a rinse cycle.

If the packages are for use in dishwashing the bodies may comprise a detergent, water-softener, salt, enzyme, rinse aid, bleach and/or bleach activator. The bodies may be adapted to release the compositions at different times during the wash. For example, a rinse aid, bleach or bleach activator is generally released at the end of a wash, and a water-softener, salt or enzyme is generally released at the start of a wash.

Examples of surface care compositions are those used in the field of surface care, for example to clean, treat or polish a surface. Suitable surfaces are, for example, household surfaces such as worktops, as well as surfaces of sanitary ware, such as sinks, basins and lavatories.

In use one or more packages are simply added to water where the outside wrapper dissolves to release the bodies inside. Thus they may be added in the usual way to a dishwasher or laundry machine, especially in the dishwashing compartment or a drum. They may also be added to a quantity of water, for example in a bucket or trigger-type spray.

In particular dish washing formulations are preferred which are adapted to be used in automatic dish washing machines. Due to their specific requirements specialised formulation is required and these are illustrated below.

The percentages amounts of ingredients referred to herein are to the total amount of that ingredient based on the total weight of the two or more bodies within the water soluble packages. Thus if three bodies are contained within the package, the percentage of a given ingredient is expressed in terms of the percentage relative to the total weight of those three bodies even if that ingredient is only present within one of those three bodies.

Amounts of the ingredients can vary within wide ranges, however preferred automatic dishwashing detergent compositions herein (which typically have a 1% aqueous solution pH of above 7, more preferably from 8 to 12, most preferably from 8 to 10.5) are those wherein there is present: from 5% to 90%, preferably from 5% to 75%, of builder; from 0.1% to 40%, preferably from 0.5% to 30%, of bleaching agent; from 0.1% to 15%, preferably from 0.2% to 10%, of the surfactant system; from 0.0001% to 1%, preferably from 0.001% to 0.05%, of a metal-containing bleach catalyst; and from 0.1% to 40%, preferably from 0.1% to 20% of a water-soluble silicate. Such fully-formulated embodiments typically further comprise from 0.1% to 15% of a polymeric dispersant, from 0.01% to 10% of a chelant, and from 0.00001% to 10% of a detersive enzyme, though further additional or adjunct ingredients may be present. Detergent compositions herein in granular form typically limit water content, for example to less than 7% free water, for better storage stability. These granular forms of the detergent composition are typically compacted to produce bodies/tablets of detergent composition.

Typically the bodies comprise one of more surfactants. If the bodies are not for use in automatic dishwashing applications they typically comprise an anionic surfactant. Such surfactants can be used in automatic dishwashing compositions but this is less preferred because anionic surfactants tend to foam too much for use in a dishwashing machine.

Examples of anionic surfactants are straight-chained or branched alkyl sulfates and alkyl polyalkoxylated sulfates, also known as alkyl ether sulfates. Such surfactants may be produced by the sulfation of higher C₈-C₂₀ fatty alcohols. Examples of primary alkyl sulfate surfactants are those of formula:

ROSO₃⁻M⁺

wherein R is a linear C₈-C₂₀ hydrocarbyl group and M is a water-solubilising cation. Preferably R is C₁₀-C₁₆ alkyl, for example C₁₂-C₁₄, and M is alkali metal such as lithium, sodium or potassium.

Examples of secondary alkyl sulfate surfactants are those which have the sulfate moiety on a “backbone” of the molecule, for example those of formula:

CH₂(CH₂)ₙ(CHOSO₃⁻M⁺)(CH₂)ₘCH₃

wherein m and n are independently 2 or more, the sum of m+n typically being 6 to 20, for example 9 to 15, and M is a water-solubilising cation such as lithium, sodium or potassium.

Especially preferred secondary alkyl sulfates are the (2,3) alkyl sulfate surfactants of formulae:

CH₂(CH₂)ₓ(CHOSO₃⁻M⁺)CH₃ and

CH₃(CH₂)ₓ(CHOSO₃⁻M⁺)CH₂CH₃

for the 2-sulfate and 3-sulfate, respectively. In these formulae x is at least 4, for example 6 to 20, preferably 10 to 16. M is cation, such as an alkali metal, for example lithium, sodium or potassium.

Examples of alkoxylated alkyl sulfates are ethoxylated alkyl sulfates of the formula:

RO(C₂H₄O)ₙSO₃⁻M⁺

wherein R is a C₈-C₂₀ alkyl group, preferably C₁₀-C₁₈ such as a C₁₂-C₁₆, n is at least 1, for example from 1 to 20, preferably 1 to 15, especially 1 to 6, and M is a salt-forming cation such as lithium, sodium, potassium, ammonium, alkylammonium or alkanolammonium. These compounds can provide especially desirable fabric cleaning performance benefits when used in combination with alkyl sulfates.

The alkyl sulfates and alkyl ether sulfates will generally be used in the form of mixtures comprising varying alkyl chain lengths and, if present, varying degrees of alkoxylation.

Other anionic surfactants which may be employed are salts of fatty acids, for example C₈-C₁₈ fatty acids, especially the sodium or potassium salts, and alkyl, for example C₈-C₁₈, benzene sulfonates.

Nonionic surfactants are the preferred surfactants for use in dishwashing applications and they may also be used in other applications in addition to, or in place of, anionic surfactants. In bodies for dishwashing applications nonionic surfactants are typically present at levels of up to 15% wt of the composition. Mixtures of nonionic surfactants may be used if desired. In general, bleach-stable surfactants are preferred. Non-ionic surfactants generally are well known, being described in more detail in Kirk Othmer's Encyclopedia of Chemical Technology, 3rd Ed., Vol. 22, pp. 360-379, “Surfactants and Detersive Systems”, incorporated by reference herein.

Examples of non-ionic surfactants are fatty acid alkoxylates, such as fatty acid ethoxylates, especially those of formula:

R(C₂H₄O)ₙOH

wherein R is a straight or branched C₈-C₁₆ alkyl group, preferably a C₉-C₁₅, for example C₁₀-C₁₄, alkyl group and n is at least 1, for example from 1 to 16, preferably 2 to 12, more preferably 3 to 10.

One class of non-ionics are ethoxylated non-ionic surfactants prepared by the reaction of a monohydroxy alkanol or alkylphenol with 6 to 20 carbon atoms with preferably at least 12 moles particularly preferred at least 16 moles, and still more preferred at least 20 moles of ethylene oxide per mole of alcohol or alkylphenol. Particularly preferred non-ionic surfactants are the non-ionics from a linear chain fatty alcohol with 16-20 carbon atoms and at least 12 moles particularly preferred at least 16 and still more preferred at least 20 moles of ethylene oxide per mole of alcohol.

The alkoxylated fatty alcohol non-ionic surfactant will frequently have a hydrophilic-lipophilic balance (HLB) which ranges from 3 to 17, more preferably from 6 to 15, most preferably from 10 to 15.

Examples of fatty alcohol ethoxylates are those made from alcohols of 12 to 15 carbon atoms and which contain about 7 moles of ethylene oxide. Such materials are commercially marketed under the trademarks Neodol 25-7 and Neodol 23-6.5 by Shell Chemical Company. Other useful Neodols include Neodol 1-5, an ethoxylated fatty alcohol averaging 11 carbon atoms in its alkyl chain with about 5 moles of ethylene oxide; Neodol 23-9, an ethoxylated primary C₁₂-C₁₃ alcohol having about 9 moles of ethylene oxide; and Neodol 91-10, an ethoxylated C₉-C₁₁ primary alcohol having about 10 moles of ethylene oxide.

Alcohol ethoxylates of this type have also been marketed by Shell Chemical Company under the Dobanol trademark. Dobanol 91-5 is an ethoxylated C₉-C₁₁ fatty alcohol with an average of 5 moles ethylene oxide and Dobanol 25-7 is an ethoxylated C₁₂-C₁₅ fatty alcohol with an average of 7 moles of ethylene oxide per mole of fatty alcohol.

Other examples of suitable ethoxylated alcohol non-ionic surfactants include Tergitol 15-S-7 and Tergitol 15-S-9, both of which are linear secondary alcohol ethoxylates available from Union Carbide Corporation. Tergitol 15-S-7 is a mixed ethoxylated product of a C₁₁-C₁₅ linear secondary alkanol with 7 moles of ethylene oxide and Tergitol 15-S-9 is the same but with 9 moles of ethylene oxide.

Other suitable alcohol ethoxylated non-ionic surfactants are Neodol 45-11, which is a similar ethylene oxide condensation products of a fatty alcohol having 14-15 carbon atoms and the number of ethylene oxide groups per mole being about 11. Such products are also available from Shell Chemical Company.

Another preferred non-ionic surfactant can be described by the formula:

R¹O[CH₂CH(CH₃)O]ₓ[CH₂CH₂O]_{y}[CH₂CH (OH)R²]

wherein R¹ represents a linear or branched chain aliphatic hydrocarbon group with 4-18 carbon atoms or mixtures thereof, R² represents a linear or branched chain aliphatic hydrocarbon rest with 2-26 carbon atoms or mixtures thereof, x is a value between 0.5 and 1.5 and y is a value of at least 15.

Another group of preferred nonionic surfactants are the end-capped polyoxyalkylated non-ionics of formula:

R¹O[CH₂CH(R³)O]ₓ[CH₂]ₖCH(OH)[CH₂]ⱼOR²

wherein R¹ and R² represent linear or branched chain, saturated or unsaturated, aliphatic or aromatic hydrocarbon groups with 1-30 carbon atoms, R³ represents a hydrogen atom or a methyl, ethyl, n-propyl, iso-propyl, n-butyl, 2-butyl or 2-methyl-2-butyl group, x is a value between 1 and 30 and, k and j are values between 1 and 12, preferably between 1 and 5. When the value of x is >2 each R³ in the formula above can be different. R¹ and R² are preferably linear or branched chain, saturated or unsaturated, aliphatic or aromatic hydrocarbon groups with 6-22 carbon atoms, where group with 8 to 18 carbon atoms are particularly preferred. H, methyl or ethyl are particularly preferred, for the group R³. Particularly preferred values for x are comprised between 1 and 20, preferably between 6 and 15.

As described above, in case x>2, each R³ in the formula can be different. For instance, when x=3, the group R³ could be chosen to build ethylene oxide (R³═H) or propylene oxide (R³=methyl) units which can be used in every single order for instance (PO) (EO) (EO), (EO) (PO) (EO), (EO) (EO) (PO), (EO) (EO) (EO), (PO) (EO) (PO), (PO) (PO) (EO) and (PO) (PO) (PO). The value 3 for x is only an example and bigger values can be chosen whereby a higher number of variations of (EO) or (PO) units would arise.

Preferably the PO units constitute up to 25% by weight, preferably up to 20% by weight and still more preferably up to 15% by weight of the overall molecular weight of the non-ionic surfactant. Particularly preferred surfactants are ethoxylated mono-hydroxy alkanols or alkylphenols, which additionally comprises polyoxyethylene-polyoxypropylene block copolymer units. The alcohol or alkylphenol portion of such surfactants constitutes more than 30%, preferably more than 50%, more preferably more than 70% by weight of the overall molecular weight of the non-ionic surfactant. Another class of non-ionic surfactants includes reverse block copolymers of polyoxyethylene and polyoxypropylene and block copolymers of polyoxyethylene and polyoxypropylene initiated with trimethylolpropane.

Particularly preferred end-capped polyoxyalkylated alcohols of the above formula are those where k=1 and j=1 originating molecules of simplified formula:

R¹O[CH₂CH(R³)O]ₓCH₂CH(OH)CH₂OR²

Further non-ionic surfactants are, for example, C₁₀-C₁₈ alkyl polyglycosides, such s C₁₂-C₁₆ alkyl polyglycosides, especially the polyglucosides. These are especially useful when high foaming compositions are desired. Further surfactants are polyhydroxy fatty acid amides, such as C₁₀-C₁₈ N-(3-methoxypropyl) glycamides and ethylene oxide-propylene oxide block polymers of the Pluronic type.

Cationic surfactants may also be used in the detergent compositions, for example, those of the quaternary ammonium type.

The bodies, particularly when used as laundry washing or dishwashing compositions, may also independently comprise enzymes, such as protease, lipase, amylase, cellulase and peroxidase enzymes. Such enzymes are commercially available and sold, for example, under the registered trade marks Esperase, Alcalase and Savinase by Nova Industries A/S and Maxatase by International Biosynthetics, Inc. Desirably the enzymes are independently present in the compositions in an amount of from 0.01 to 3 wt %, especially 0.01 to 2 wt %, when added as commercial preparations they are not pure and this represents an equivalent amount of 0.005 to 0.5 wt % of pure enzyme.

Bodies which comprise an enzyme may optionally contain materials which maintain the stability of the enzyme. Such enzyme stabilizers include, for example, polyols such as propylene glycol, boric acid and borax. Combinations of these enzyme stabilizers may also be employed. If utilized, the enzyme stabilizers generally constitute from 0.01 to 2 wt % of the bodies.

The bodies usually comprise a detergency builder. The builders counteract the effects of calcium, or other ion, water hardness. Examples of such materials are citrate, succinate, malonate, carboxymethyl succinate, carboxylate, polycarboxylate and polyacetyl carboxylate salts, for example with alkali metal or alkaline earth metal cations, or the corresponding free acids. Specific examples are sodium, potassium and lithium salts of oxydisuccinic acid, mellitic acid, benzene polycarboxylic acids, C₁₀-C₂₂ fatty acids and citric acid. Other examples are organic phosphonate type sequestering agents such as those sold by Monsanto under the trade mark Dequest and alkylhydroxy phosphonates. Citrate salts and C₁₂-C₁₈ fatty acid soaps are preferred. Further builders are; phosphates such as sodium, potassium or ammonium salts of mono-, di- or tri-poly or oligo-phosphates; zeolites; silicates, amorphous or structured, such as sodium, potassium or ammonium salts. For laundry compositions, alumino silicates (zeolites) may also be used and these are less preferred in automatic dishwashing applications.

Other suitable builders are polymers and copolymers known to have builder properties. For example, such materials include appropriate polyacrylic acid, polymaleic acid, and polyacrylic/polymaleic and copolymers and their salts, such as those sold by BASF under the trade mark Sokalan.

The builder is desirably present in an amount of up to 90 wt %, preferably 0.01 to 90 wt %, more preferable 0.01 to 75 wt %, relative to the total weight of the composition.

Further details of suitable components are given in, for example, EP-A-694,059, EP-A-518,720 and WO 99/06522.

The bodies may comprise conventional bleaching compounds and bleach activators in conventional amounts. If a bleaching compound is used in the compositions of the invention, then any type of bleaching compound conventionally used in detergent compositions may be used. Preferably the bleaching compound is selected from inorganic peroxides or organic peracids, derivatives thereof (including their salts) and mixtures thereof. Especially preferred inorganic peroxides are percarbonates, perborates and persulphates with their sodium and potassium salts being most preferred. Sodium percarbonate and sodium perborate are most preferred, especially sodium percarbonate.

Organic peracids include all organic peracids traditionally used as bleaches, including, for example, perbenzoic acid and peroxycarboxylic acids such as mono- or diperoxyphthalic acid, 2-octyldiperoxysuccinic acid, diperoxydodecanedicarboxylic acid, diperoxy-azelaic acid and imidoperoxycarboxylic acid and, optionally, the salts thereof. Especially preferred is phthalimidoperhexanoic acid (PAP).

When a bleaching compound is present in the bodies, it is preferably present in an amount of from 1 to 60 wt %, especially 5 to 55 wt %, most preferably 10 to 50% wt, such as 10 to 20% wt.

If a bleaching compound is used, it may be used with any suitable bleach activator compound, such as TAED or any multi-valent metal ion compounds or salts as known in the art. Such a compound may be used in any suitable amount.

The bodies may optionally comprise materials which serve as phase stabilizers and/or co-solvents. Examples are C₁-C₃ alcohols such as methanol, ethanol and propanol. C₁-C₃ alkanolamines such as mono-, di- and triethanolamines can also be used, by themselves or in combination with the alcohols. The phase stabilizers and/or co-solvents can, for example, constitute 0 to 1 wt %, preferably 0.1 to 0.5 wt %, of the composition.

The bodies may optionally comprise components which adjust or maintain the pH of the compositions at optimum levels. The pH may be from, for example, 1 to 13, such as 8 to 11 depending on the nature of the composition. For example a dishwashing composition desirably has a pH of 8 to 11, a laundry composition desirable has a pH of 7 to 9, and a water-softening composition desirably has a pH of 7 to 9. Examples of pH adjusting agents are soda ash (Na₂CO₃) and citric acid.

The bodies can also optionally comprise one or more additional ingredients. These include conventional detergent composition components such as suds boosters or suds suppressors, anti-tarnish and anti-corrosion agents, organic solvents, co-solvents, emulsifying agents, preservatives, soil suspending agents, soil release agents, germicides, non-builder alkalinity sources, chelating agents, clays such as smectite clays, anti-limescale agents, colourants, dyes, hydrotropes, dye transfer inhibiting agents, brighteners, and perfumes. If used, such optional ingredients may constitute up to 60 wt %, for example from 1 to 50 wt %, the total weight of the compositions.

### Packaging

The water soluble packages may themselves be packaged in outer containers if desired, for example non-water soluble containers from which the packages are removed before the water-soluble packages are used. Any suitable type of outer containers may be used. However, according to a preferred embodiment the packages are placed in the primary package as described hereinbelow.

Thus it is preferred according the invention that the water soluble package of the invention is contained within a primary package comprising two or more compartments which can be opened individually, each compartment comprising a plurality of packages according to the invention and wherein at least one compartment of the primary package is substantially air-tight before it is opened for the first time.

The primary package comprises two or more compartments which are opened and closed individually.

The primary package preferably comprises three or more of the aforementioned compartments, such as four or more. In some cases it is desirable for the package to comprise five or more compartments.

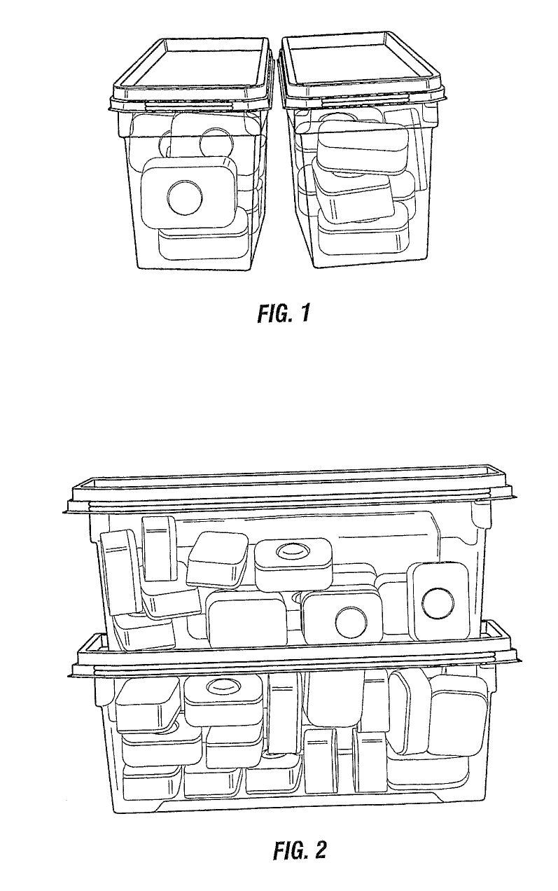

The compartments may be arranged in any suitable spatial arrangement relative to each other to produce the primary package. For example the compartments may be arranged side-by-side as shown in FIG. 1. Alternatively the compartments may be arranged so that they are stacked on top of each other as shown in FIG. 2. In a further embodiment it is provided for a mixture of stacking and adjacent compartments to be used e.g. 2 or 3 compartments may be placed adjacent to each other and a additional compartments placed thereon. For example an additional compartment may be stacked on top of each of two adjacent compartments so that there are four compartments placed two wide and stacked two high. The same arrangement could be used for any desired number of compartments.

The two or more compartments which form the primary package of the invention may either permanently, or reversibly, be bound to each other. If the compartments are permanently bound to each other they may be formed from a single piece of material e.g. plastics material. If the compartments are reversibly bound to each other they may be adhered to each other by an adhesive bond which is broken to separate the compartments or they may be reversibly bound in some other way such as by the use of an outer wrapper or by a frangible connection between the compartments.

According to a preferred embodiment of the present invention the two or more compartments are reversibly bound to each other to form the primary package. It is especially preferred that three or more compartments are reversibly bound to each other to form the primary package.

It is preferred that a wrapper placed around at least a part of the primary package is used to reversibly bind the two or more compartments together. This wrapper is preferably placed around two or more compartments either stacked on top of each other or placed in a side-by-side arrangement. The wrapper may cover all, or substantially all of the exposed face(s) of the compartments, or it may cover the whole or a part of only some of those faces. It is especially preferred that at least one of the faces of each of the compartments is not covered by the wrapper to allow the contents of the compartments to be viewed by the consumer. It is especially preferred that at least two faces of each of the compartments are not covered by the wrapper to provide very good visibility to the consumer of the wrapped bodies contained within the compartment. If the wrapper covers substantially all of the faces of the compartments in the primary package, it is then preferred that the water soluble bodies in at least one of the compartments can be viewed through the wrapper by the consumer.

The wrapper is preferably arranged around the perimeter of the primary package formed by the two or more compartments of the primary package. It is of any suitable dimensions and material so as to provide additional dimensional stability to the primary package compared to the package in the absence of the outer wrapper where this is necessary by virtue of the spatial arrangement of the two or more compartments in relation to each other. The wrapper may be applied to the primary package by any suitable conventional method. For the reversibly bound compartments, the primary package is typically formed by bringing together the two or more compartments in the chosen arrangement and then the outer wrapper is applied thereto. When the primary package is formed from permanently bound compartments, the package is formed and the wrapper is applied thereto. In both cases the wrapper may be applied as loosely or tightly fitting as desired. However in the cases where the outer wrapper is applied to non-permanently joined compartments, such as compartments which are not physically joined but which are simply stacked on top of each other, the wrapper is preferably applied in a manner such that it is relatively close fitting and provides additional dimensional stability to the stack.

The wrapper may be formed of paper (especially waxed or reinforced paper), cardboard or sheets of plastic material such as polyethylene or polypropylene based polymers. It may provide printed information on the product as desired, or, it may be blank and it may be transparent, semi-transparent or opaque as desired.

In a particularly preferred embodiment of the present invention the compartments are reversibly connected to each other by the use of one or more adhesive bonds and also by an wrapper as hereinabove described.

At least one compartment of the primary package is substantially air-tight before it is opened, preferably two or more compartments are substantially air-tight before they are opened and most preferably three or more are substantially air-tight before they are opened for the first time. It is most preferred that regardless of how many compartments make up the primary package that they are all substantially air-tight before they are opened for the first time.

The substantially air-tight seal may be formed in any suitable way using any suitable material. The at least one compartment which is substantially air-tight before it is opened for the first time preferably comprises a substantially air-tight closure means adhered to the compartment. This may take the form of a seal arranged such that it can easily be removed by the consumer when opening the compartment for the first time. Suitable substantially air-tight seals include closure means comprising a flexible web of material, such as a foil, bonded to the compartment e.g. around the edges of the closure means and which are removed by simply peeling it away from the compartment, often aided by a tab placed on one edge or corner of the closure means. Such substantially air-tight seals are known in the art and do not require further description here.

The two or more compartments of the primary package are opened individually. Preferably they are also closed individually. This means that when one compartment is opened by removing a part of that compartment thus breaking the substantially air tight seal, the seals of the other compartments remain intact until it is decided by the consumer to break the seal and open the compartment. Accordingly the consumer has the choice of which compartment to open first and when there are three or more compartments also the choice of in which order to open those compartments. Thus the consumer may choose to open the compartments sequentially; as each compartment becomes empty of tablets he/she will choose which compartment to open next. It is of course possible that the consumer may choose to open all compartments at about the same time but this is less preferred as the advantages of the invention are less likely to be achieved.

When a compartment has been opened by breaking its substantially airtight seal in order to remove one or more wrapped bodies, the compartment may be closed by any suitable closure means. This closure of the compartment with the closure means may or may not result in a substantially air-tight seal for the compartment being reformed. It is thus preferred that the package comprises a further individual closure means for one or more compartments.

Suitable closure means may comprise tongue-and-groove means or faster means such as zip fastener means to connect to the compartment. According to a preferred aspect of the invention tongue-and-grove means are preferred.

Typically the closure means comprises a lid which covers the open part of the compartment formed by the removal of the substantially airtight seal. The lid engages with the perimeter of the open part of the compartment and preferably positively engages therewith. After the compartment has been opened for the first time by removing the substantially air tight seal, the lid is then removed each time it is desired to take a unit dose detergent portion from the compartment. When the substantially airtight seal is still attached to the compartment, the lid preferably sits above this seal (relative to the compartment) and is also in contact with the compartment.

The lid may be designed so that it has an vertically protruding lip on at least a portion of its upper surface (the upper surface being that surface which faces outwards when affixed to the compartment) to provide an additional means for aiding the stability of the primary package when it comprises two or more compartments in a stacked arrangement. This protruding lip aids dimensional stability of stacked compartments as it provides a physical barrier to prevent the compartments moving relative to each other during transport and handling etc and thus reduces the likelihood of one of the compartments in the stack falling off the compartment below. The protruding lip of the lid may be of any suitable height and width but it will not typically be more than 30% of the height of the compartment to which the lid is attached, preferably not more than 20%. Typically the lip will be in the region of 5-10% of the height of said compartment. For the reasons of dimensional stability it is therefore especially preferred that two or more compartments of the primary package have a protruding lip on the lid (used as a closure means once the airtight seal has been removed) and furthermore are reversibly bound together by an wrapper as described hereinabove.

According to one preferred embodiment of the present invention the lid has the aforementioned protruding lip around the perimeter of its upper surface (the upper surface being relative to when it is placed on the compartment) and this lip is shaped so as to allow for an wrapper to engage with the lip across only a proportion thereof without the wrapper protruding above the highest part of the protruding lip. This shaped portion of the protruding lip can take the form of a cut-away section which substantially corresponds to the shape of the wrapper which contacts the lip.

The compartments and closure means (lid) may be made of any suitable material, preferably a plastics material. Examples of suitable plastics are well known in the packaging art and include materials such as polypropylene, polyethylene (low and high density), polyethylene terephalate, Polystyrene, Expanded Polystyrene, Acrylonitrite Butadiene Styrene, Polyvinyl Chloride, Polyester and mixtures thereof. The actual material, or mixtures of materials used is easily selected by the person skilled in the art on the basis of the degree of transparency desired, the method by which the compartments/closure means will be produced and the required degree of rigidity or flexibility.

According to one embodiment of the present invention it is preferred that at least one compartment in the primary package is substantially transparent to the naked eye, preferably transparent to the naked eye, so that the wrapped bodies can be seen when placed inside a closed compartment. It is most preferred that two or more compartments are substantially transparent and further preferred that all compartments are substantially transparent. It is especially preferred that two or more compartments are substantially transparent and further preferred that all compartments are substantially transparent. The closure means (lid) may be either transparent or opaque as desired. In one preferred embodiment at least one of the compartments of the primary package is transparent and the closure means (lid) thereof is translucent or opaque, preferably all compartments are transparent and all closure means (lids) are translucent or opaque, more preferably opaque.

The compartments and closure means (lid) may be as flexible or as rigid as desired. However, whilst a degree of flexibility is desirable to avoid breakages in transport caused by a very brittle compartment not being able to absorb impacts normally encountered during filling and transport, the compartments and closure means (lid) are preferably sufficiently rigid to allow for at least one more identical compartment with its contents to be stacked on the top of a given compartment without the bottom compartment visibly deforming. It is more preferred that at least two additional identical compartments and their contents may be stacked on the top of a given compartment without it visibly deforming, more preferably at least three.

The compartments may be produced by any conventional technical for the manufacture of plastic articles, especially the methods used for the manufacture of plastic packaging items, such as thermoforming or injection or blow moulding. Such techniques are well known in the art and do not need to be described in detail herein.

Each compartment of the primary package contains a plurality of water-soluble wrapped packages of the invention. It is preferred that each compartment comprises at least 2 such bodies, more preferably at least 5 such packages, most preferably at least 10 such packages, such as 12 or more packages. It is also preferred that each compartment contains up to 50 packages, more preferably up to 40, most preferably up to 30, such as up to 20.

The total number of water soluble packages containing the water soluble bodies in the primary package can of course easily be controlled by selecting the appropriate combination of the number of packages per compartment and the number of compartments in the primary package. It is preferred that the primary package contains a total of between 10 and 100 packages, preferably between 15 and 80 packages, more preferably between 20 and 60, such as between 30 and 50. This total number of packages is divided either equally or unequally over the two or more compartments of the primary package. It is generally preferred that the total number of packages is divided equally over the two or more compartments of the primary package.

The invention will now be described further with reference to the following example.

### EXAMPLE 1

Two layers of different detergent composition were compacted together to form a two layer tablet. The upper layer had a circular recess in the upper face into which was placed a further separate phase having a substantially spherical appearance. Thus a detergent tablet was produced. A water soluble film of very close-fitting polyvinyl alcohol was applied and sealed around the tablet. The water soluble wrapper was sufficiently tight fitting that the tablet remain intact even in the absence of an adhesive agent holding the different layers and sphere of the tablet together.

Fourteen of the wrapped tablets were placed in a transparent plastic compartment and a foil was applied over the open face of the compartment and a reversible bond formed at the perimeter of the foil where it contacted the perimeter of the compartment. A substantially airtight seal was thus formed. Two further compartments were filled and sealed in the same manner. A plastic lid, having a lip that protruded above the planar surface of the lid (to a height of about 10% of the height of the compartment) and forming a part of a tongue and groove arrangement for connection to the compartment, was applied to each of the three compartments.

Two of the compartments were stacked onto the third compartment to make a ‘tower’ of three compartments. A close fitting plastic wrapper was then applied around the exterior of the tower formed by the three compartments so that it covered the front and back faces of the compartments but not the end faces to produce the primary package of the invention.

To access the tablets, the plastic lid was removed on one of the compartments, the substantially air-tight seal was broken and the tablet(s) removed by hand. To close the compartment the plastic lid was applied thereto and was held in place by the tongue-and-groove arrangement. Each compartment could be opened and closed individually.

The tablets in the compartments showed good stability (physical and chemical) for all 42 dishwashing tablets. The tablets remained intact during normal handling procedures.

1. A water-soluble package comprising at least two water-soluble bodies, wherein the at least two bodies are not adhered to each other by an adhesive and are retained in positions relative to one another by a water-soluble film surrounding the bodies.

2. A package according to claim 1 wherein at least one of said bodies is a compressed particulate composition.

3. A package according to claim 1 wherein at least one body comprises an indentation into which is situated a second body.

4. A package according to claim 3 wherein the second body is spherical.

5. A package according to claim 1 which is a fabric care package, a surface care package or a dishwashing package.

6. A package according to claim 1 wherein the water-soluble film is a poly(vinyl alcohol) film.

7. A package according to claim 1 wherein the water-soluble film is thermoformed.

8. A primary package comprising two or more compartments which can be opened individually, each compartment comprising a plurality of packages according to claim 1 and wherein at least one compartment of the primary package is substantially air-tight before it is opened for the first time.

9. A package according to claim 1 wherein at least two of said bodies is a compressed particulate composition.

10. A package according to claim 9 wherein at least one body comprises an indentation into which is situated a second body.

11. A package according to claim 3 wherein the second body is spherical.

16. A package according to claim 9 which is a fabric care package, a surface care package or a dishwashing package.

17. A package according to claim 9 wherein the water-soluble film is a poly(vinyl alcohol) film.

18. A package according to claim 9 wherein the water-soluble film is thermoformed.
